(19) United States
(12) Patent Application Publication
(10) Pub. No.: US 2015/0300562 A1
(43) Pub. Date: Oct. 22, 2015

(54) PLANT, BIRD HOUSE, AND BIRD FEEDER HOLDER

(71) Applicant: Glenn P. Gillen, Metairie, LA (US)

(72) Inventor: Glenn P. Gillen, Metairie, LA (US)

(21) Appl. No.: 14/549,333

(22) Filed: Nov. 20, 2014

Related U.S. Application Data
(60) Provisional application No. 61/944,399, filed on Feb. 25, 2014.
(60) Provisional application No. 61/907,226, filed on Nov. 21, 2013.

(51) Int. Cl. F16M 13/02; A01K 29/00; A01K 45/00; A47G 7/04

(52) U.S. Cl. CPC F16M 13/022; A47G 7/047; F16M 13/02; A01K 29/00; A01K 45/00

(57) ABSTRACT

A support apparatus is provided for hanging an object (e.g., plant, hanging plant, bird feeder or bird house) upon a fence that is constructed of a plurality of vertical fence panels, wherein there is a gap between each pair of fence panels. The device includes a frame having an upper beam with first and second ends and a lower beam having first and second ends, the first end being joined to the first end of the upper beam, and wherein the upper and lower beams form an acute angle. The frame also includes a vertical member that is connected to the second end of the upper beam at an upper position, the vertical member having an opening next to the upper beam. The vertical member is connected to the second end of the lower beam at a lower position that is lower than said upper position. There is a plant holding recess at the free end for cradling a lift cable part of the plant. An externally threaded fastener extends through the upper opening, the fastener being sized and shaped to fit in between two adjacent fence panels of the fence. A plate is connected to the fastener. A nut having internal threads engages the external threads of the fastener for applying compression to the fence panels that are in between the plate and the vertical member. In a second embodiment, the fastener includes a spring.

### CROSS-REFERENCE TO RELATED APPLICATIONS

Priority of U.S. Provisional Patent Application Ser. No. 61/907,226, filed 21 Nov. 2013, and U.S. Provisional Patent Application Ser. No. 61/944,399, filed 25 Feb. 2014, each of which is hereby incorporated herein by reference, is hereby claimed.

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND OF THE INVENTION

1. Field of the Invention

The present invention relates to hangers for holding plants, bird houses, bird feeders and like elevated support devices. More particularly, the present invention relates to an improved hanger apparatus that is configured to be attached to a fence that is constructed of horizontal beams or stringers and vertical panels. More particularly, the present invention relates to an improved hanger apparatus configured to be attached to a fence wherein vertical panels of the fence have a gap (or a gap can be formed between two panels) and wherein the apparatus includes a bracket having a frame with a lower plate that engages the forward or front surface of a fence and a second plate that is positioned behind the fence and at a position above the lower plate and wherein a fastener extends through the frame and the upper plate for holding the assembly to the fence and for applying compression to the fence between the frame and the upper plate.

2. General Background of the Invention

Hanging plants, bird houses and bird feeders are commonly used in outdoor areas. Hanging plants, bird houses and bird feeders are often supported upon a fence by nailing or permanently affixing a bracket to the fence and hanging a plant from the bracket.

One patent has issued which has attempted to provide a hanger that can be attached to a wooden fence, that device is shown in U.S. Pat. No. 4,666,115 which is incorporated herein by reference.

The following US patents are incorporated herein by reference:

| Patent No. | Title | Issue Date |
|---|---|---|
| 4,666,115 | Plant Hanger | 19 May 1987 |

These prior art systems suffer in that they employ nails or fasteners that become dislodged over time causing the plant to fall to the ground and damaging or breaking the pot portion of the arrangement.

### BRIEF SUMMARY OF THE INVENTION

The present invention provides a support apparatus for hanging a bird feeder, bird house, or plant containing hanging basket (that can be fitted with one or more cables, chains or rope hangers) upon a fence that is constructed of a plurality of vertical fence panels, wherein there is a gap between each pair of fence panels.

The apparatus provides a frame having multiple beams including an upper beam having first and second ends, a lower beam having first and second ends, the first end being joined to the first end of the upper beam, and wherein the upper and lower beams form an acute angle.

The frame also includes a vertical member that can be connected to the second end of the upper beam at an upper position, the vertical member having an opening next to the upper beam.

The vertical member can be connected to the second end of the lower beam at a lower position that can be lower than the upper position.

A recess at the free end cradles the lift cable part of the plant or bird feeder.

An externally threaded fastener extends through the upper opening, the fastener being sized and shaped to fit in between two adjacent fence panels of the fence.

A plate can be connected to the fastener.

A nut having internal threads engages the external threads of the fastener for applying compression to the fence panels that are in between the plate and the vertical member.

In one embodiment, the vertical member can have a width and the plate can have a plate width and a plate height each greater than said vertical member width.

In one embodiment, the fastener includes a spring portion.

In one embodiment, the apparatus provides no structure in between the vertical member and the plate other than the fastener.

In one embodiment, the fastener can be connected to the plate at a plate opening.

In one embodiment, the nut can be secured to an end portion of the fastener that extends in front of the fence and through the vertical member opening.

In one embodiment, the nut can be secured to an end portion of the fastener that extends in back of the fence and through both the vertical member opening and a plate opening.

In one embodiment, the nut can be secured to an end portion of the fastener that extends either in front of the fence or behind the fence and through both the vertical member opening and a plate opening.

In one embodiment, the fastener can be a threaded bolt having a bolt head and a threaded shaft attached to the bolt head.

The present invention includes an apparatus for hanging an object upon a fence that is constructed of a plurality of vertical fence panels, wherein there is a gap between each pair of fence panels. The apparatus includes an upper beam having first and second ends, the first end having a free end, a lower beam having first and second ends, the first end being joined to the first end of the upper beam, and wherein the upper and lower beams can form an acute angle. The apparatus further includes a vertical member that can be connected to the second end of the upper beam at an upper position, the vertical member having an opening next to the upper beam, the vertical member being connected to the second end of the lower beam at a lower position that can be lower than said upper position. The apparatus further includes an object holding recess at the free end for cradling a lift cable part of the object, an externally threaded fastener that extends through said upper opening, the fastener being sized and shaped to fit in between two adjacent fence panels of the fence. The apparatus further includes a plate connected to the fastener, and a nut having internal threads that engage the external threads of the fastener for applying compression to the fence panels that are in between the plate and the vertical member.

The apparatus of the present invention includes a support apparatus for hanging an object upon a fence that is constructed of a plurality of vertical fence panels, wherein there is a gap between each pair of fence panels, the apparatus including a frame that includes an upper beam having first and second ends and a lower beam having first and second ends, the lower beam first end being joined to the first end of the upper beam, and wherein the upper and lower beams form an acute angle. The frame can include a vertical member that is connected to the second end of the upper beam at an upper position, the vertical member having an opening next to the upper beam. The vertical member can be connected to the second end of the lower beam at a lower position that is lower than said upper position. The apparatus further includes an object holding recess at a free end of the upper beam first end for cradling a lift cable part of the object, a spring loaded device that extends through said upper opening, the spring loaded device being sized and shaped to fit in between two adjacent fence panels of the fence. Both the vertical member and a plate can be connected to the spring loaded member.

In one embodiment, the spring loaded member can be a coil spring.

In one embodiment, the spring loaded member can be an elastic member.

In one embodiment, the spring loaded device includes a coil spring.

In one embodiment, the spring loaded device includes an elastic member.

In one embodiment, the spring loaded device includes a threaded portion and a coil spring.

In one embodiment, the object can be a bird feeder, bird house or hanging plant.

### BRIEF DESCRIPTION OF THE SEVERAL VIEWS OF THE DRAWINGS

For a further understanding of the nature, objects, and advantages of the present invention, reference should be had to the following detailed description, read in conjunction with the following drawings, wherein like reference numerals denote like elements and wherein:

FIG. 1 is a perspective view of a preferred embodiment of the apparatus of the present invention;

FIG. 1A is a fragmentary perspective view of a preferred embodiment of the apparatus of the present invention;

FIG. 2 is a perspective view of a preferred embodiment of the apparatus of the present invention;

FIG. 3 is a perspective view of a preferred embodiment of the apparatus of the present invention;

FIG. 4 is a fragmentary side view of a preferred embodiment of the apparatus of the present invention;

FIG. 5 is another fragmentary side view of a preferred embodiment of the apparatus of the present invention.

FIGS. 6-8 are fragmentary views of a preferred embodiment of the apparatus of the present invention showing an alternate fastener arrangement.

### DETAILED DESCRIPTION OF THE INVENTION

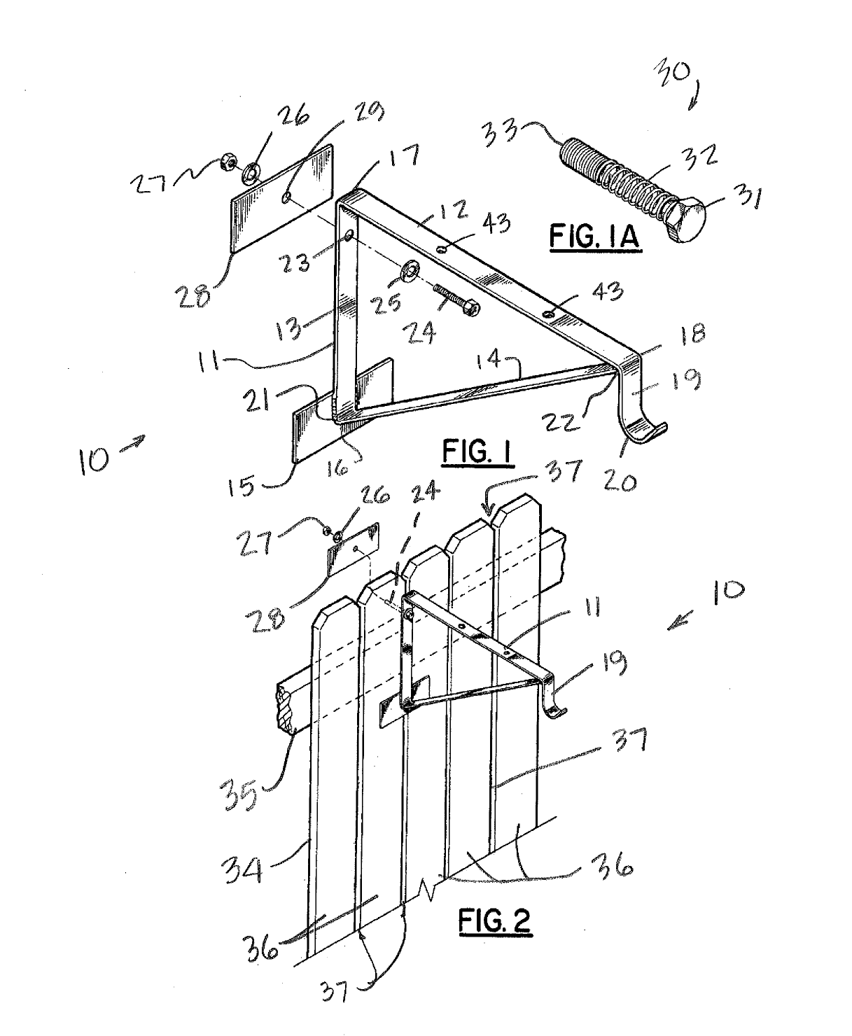

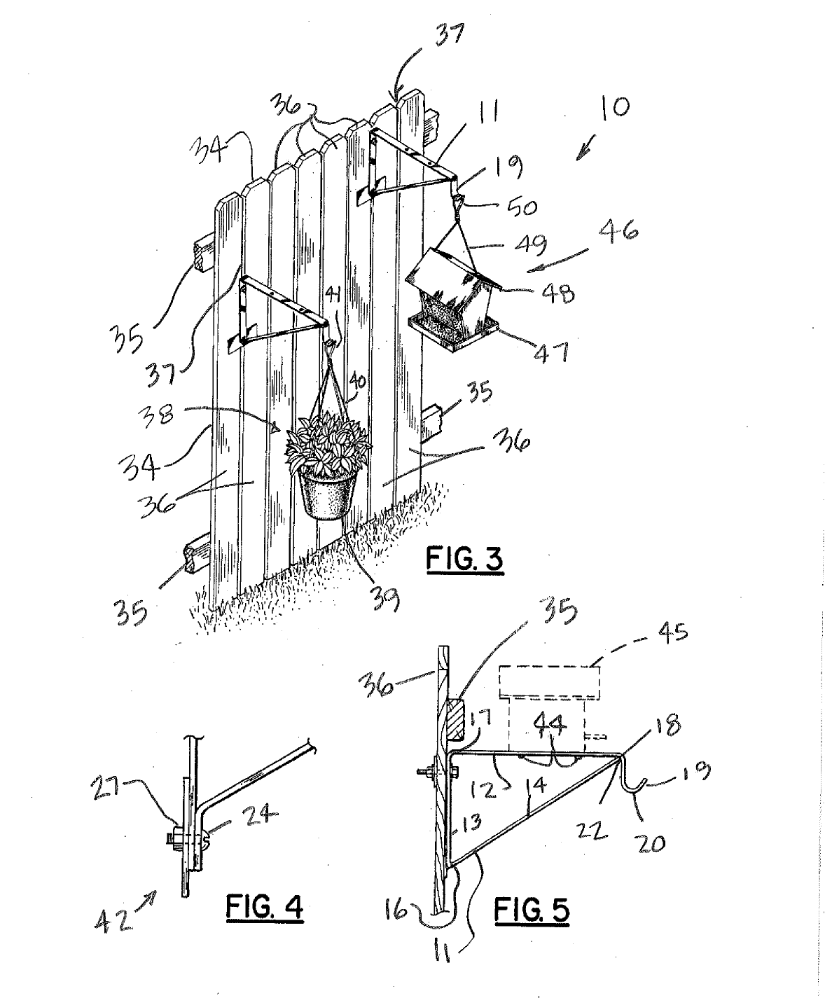

FIGS. 1-8 show a preferred embodiment of the apparatus of the present invention designated generally by the numeral 10 and configured to attach to a fence 34 (see FIGS. 2-3). Hanger apparatus 10 employs a frame 11 preferably constructed of metal, plastic or fiberglass. The frame 11 can be generally triangularly shaped as shown in the side view of FIGS. 1 and 5. Frame 11 includes an upper section 12 that can be generally horizontally positioned and a lower diagonally positioned section 14. The upper section 12 and the lower section 14 are connected (e.g., welded) to vertical section 13 as shown in FIG. 1. Alternatively, the frame 11 can be constructed of a single bar of metal that is bent to the shape of FIGS. 1 and 5. Openings 43 in upper section 12 can accept fasteners 44 (e.g., wood screws, bolts, nails) for enabling an attachment of bird house 45 (see FIG. 5).

The apparatus 10 employs a pair of plates including lower plate 15 and upper plate 28. The lower plate 15 can be connected (for example welded) to frame 11 at weld 21. Frame 11 has a plurality of bends 16, 17, 18. The bend 16 connects sections 13 and 14. The bend 17 connects sections 12 and 13. The bend 18 is part of a hook 19 that includes curved part 20. Weld 22 connects lower section 14 to upper section 12 at bend 18.

Vertical section 13 has opening 23 that is receptive of bolt 24 as shown in FIGS. 1, 2, 4 and 5. Washers 25, 26 and nut 27 enable a bolted connection to be made between bolt 24 and plate 28. The bolted connection can be formed by placing washer 25 on bolt 24 and then inserting the bolt 24 through both the opening 23 of frame 11 and the opening 29 of plate 28. Washer 26 and nut 27 are then connected to bolt 24 after it passes through the openings 23, 29. The completed bolted connection is generally designated as numeral 42 in FIGS. 4 and 5.

FIG. 1A shows an alternate device that replaces bolt 24. The device 30 is a spring loaded fastener 30 having a head 31 to which is connected (for example welded) a coil spring 32. Opposite head 31, an externally threaded section 33 is connected to coil spring 32 again, using welding for example. The device 30 enables the application of spring loaded compression to the fence 34. Additionally, the device 30 could be connected to frame 11 before attachment to fence 34. A user could then stretch the coil spring 32 just before placing frame 11 in front of the fence 34 and upper plate 28 behind the fence 34 (see for example FIG. 8).

FIGS. 1-3 show a fence 34 to which apparatus 10 is connected. Fence 34 is constructed of a plurality of horizontal boards or stringers 35 and a plurality of vertical panels 36. Typically there is a small gap 37 in between each pair of vertical panels 36. Alternatively, if the gap 37 is very small, a hole can be drilled that is sized and shaped to accept bolt 24 or device/spring loaded fastener 30. As seen in FIGS. 2, 3 and 5 the apparatus 10 can be installed on fence 34 on the same side as stringers 35 (see FIG. 5) or on the side of fence 34 opposite stringers 35 (FIGS. 2-3).

Plant 38 (see FIG. 3) includes a basket or pot 39 which is supported upon ropes, cables or chain hangers 40. Such a rope/cable/chain hanger arrangement is commercially available, typically providing an upper eyelet 41 or other hanger that would form a connection with the curved part 20 of hook 19 of frame 11. Bird feeder 46 can similarly be attached to hook 19. Feeder 46 can be provided with platform 47, roof 48, cable or cables 49 and eyelet 50. Eyelet 50 attaches to hook 19.

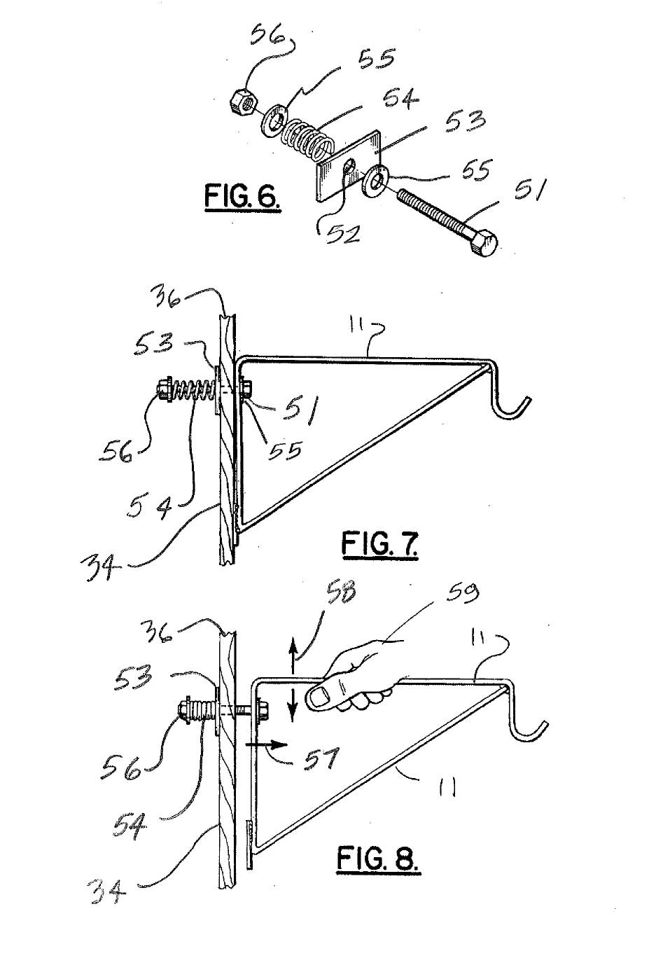

FIGS. 6-8 show an alternate arrangement for securing frame 11 to fence 34. Bolt 51 passes through opening 23 in frame 11. Washer 55 can be placed on bolt 51 against frame 11 (see FIG. 7). Behind fence 34, plate 53 has opening 52 that is receptive of bolt 51. Coil spring 54 is placed on bolt 51 after it passes through the gap 37 between two adjacent fence panels 36. Washer 55 and nut 56 are then attached to bolt 51 (see FIGS. 6-7). A user 59 can pull on frame 11 compressing spring 54 (see arrow 57) and then move frame 11 up or down (see arrows 58).

The following is a list of parts and materials suitable for use in the present invention:

PARTS LIST:

| PART NUMBER | DESCRIPTION |
|---|---|
| 10 | hanger apparatus |
| 11 | frame |
| 12 | upper section/horizontal member |
| 13 | vertical section |
| 14 | lower section/diagonal member |
| 15 | lower plate |
| 16 | bend |
| 17 | bend |
| 18 | bend |
| 19 | hook |
| 20 | curved part |
| 21 | weld |
| 22 | weld |
| 23 | opening |
| 24 | bolt |
| 25 | washer |
| 26 | washer |
| 27 | nut |
| 28 | upper plate |
| 29 | plate opening |
| 30 | device/spring loaded fastener |
| 31 | head |
| 32 | coil spring |
| 33 | externally threaded section |
| 34 | fence |
| 35 | horizontal board/stringer |
| 36 | vertical panel/fence panel |
| 37 | gap |
| 38 | plant |
| 39 | basket/pot |
| 40 | rope/cable/chain hanger |
| 41 | eyelet |
| 42 | bolted connection |
| 43 | opening |
| 44 | fastener/screw/nail/bolt |
| 45 | bird house |
| 46 | bird feeder |
| 47 | platform |
| 48 | roof |
| 49 | cable/cables |
| 50 | eyelet |
| 51 | bolt |
| 52 | opening |
| 53 | plate |
| 54 | coil spring |
| 55 | washer |
| 56 | nut |
| 57 | arrow |
| 58 | arrow |
| 59 | user |

All measurements disclosed herein are at standard temperature and pressure, at sea level on Earth, unless indicated otherwise. All materials used or intended to be used in a human being are biocompatible, unless indicated otherwise.

The foregoing embodiments are presented by way of example only; the scope of the present invention is to be limited only by the following claims.

1. An apparatus for hanging an object upon a fence that is constructed of a plurality of vertical fence panels, wherein there is a gap between each pair of fence panels, comprising:
a) an upper beam having first and second ends, the first end having a free end;
b) a lower beam having first and second ends, the first end being joined to the first end of the upper beam, and wherein the upper and lower beams form an acute angle;
c) a vertical member that is connected to the second end of the upper beam at an upper position, the vertical member having an opening next to the upper beam;
d) the vertical member being connected to the second end of the lower beam at a lower position that is lower than said upper position;
e) an object holding recess at the free end for cradling a lift cable part of the object;
f) an externally threaded fastener that extends through said upper opening, the fastener being sized and shaped to fit in between two adjacent fence panels of the fence;
g) a plate connected to the fastener; and
h) a nut having internal threads that engage the external threads of the fastener for applying compression to the fence panels that are in between the plate and the vertical member.

2. The apparatus of claim 1 wherein the vertical member has a width and the plate has a plate width and a plate height each greater than said vertical member width.

3. The apparatus of claim 1 wherein the fastener includes a spring portion.

4. The apparatus of claim 1 wherein the apparatus provides no structure in between the vertical member and the plate other than the fastener.

5. The apparatus of claim 1 wherein the fastener is connected to the plate at a plate opening.

6. The apparatus of claim 1 wherein the nut is secured to an end portion of the fastener that extends in front of the fence and through the vertical member opening.

7. The apparatus of claim 1 wherein the nut is secured to an end portion of the fastener that extends in back of the fence and through both the vertical member opening and a plate opening.

8. The apparatus of claim 1 wherein the nut can be secured to an end portion of the fastener that extends either in front of the fence or behind the fence and through both the vertical member opening and a plate opening.

9. The apparatus of claim 5 wherein the fastener is a threaded bolt having a bolt head and a threaded shaft attached to the bolt head.

10. A support apparatus for hanging an object upon a fence that is constructed of a plurality of vertical fence panels, wherein there is a gap between each pair of fence panels, comprising:
a) a frame that includes an upper beam having first and second ends and a lower beam having first and second ends, the lower beam first end being joined to the first end of the upper beam, and wherein the upper and lower beams form an acute angle;
b) the frame including a vertical member that is connected to the second end of the upper beam at an upper position, the vertical member having an opening next to the upper beam;
c) the vertical member being connected to the second end of the lower beam at a lower position that is lower than said upper position;
d) an object holding recess at a free end of the upper beam first end for cradling a lift cable part of the object;
e) a spring loaded device that extends through said upper opening, the spring loaded device being sized and shaped to fit in between two adjacent fence panels of the fence; and
f) both the vertical member and a plate connected to the spring loaded member.

11. The support apparatus of claim 10 wherein the spring loaded member is a coil spring.

12. The support apparatus of claim 10 wherein the spring loaded member is an elastic member.

13. The support apparatus of claim 10 wherein the spring loaded device includes a coil spring.

14. The support apparatus of claim 10 wherein the spring loaded device includes an elastic member.

15. The support apparatus of claim 10 wherein the spring loaded device includes a threaded portion and a coil spring.

16. The apparatus of claim 1 wherein the object is a bird feeder, bird house or hanging plant.

17. (canceled)

18. The apparatus of claim 10 wherein the object is a bird feeder, bird house or hanging plant.

19. The apparatus of claim 6 wherein the fastener is a threaded bolt having a bolt head and a threaded shaft attached to the bolt head.

20. The apparatus of claim 7 wherein the fastener is a threaded bolt having a bolt head and a threaded shaft attached to the bolt head.

21. The apparatus of claim 8 wherein the fastener is a threaded bolt having a bolt head and a threaded shaft attached to the bolt head.
